(19) United States
(12) Patent Application Publication
(10) Pub. No.: US 2005/0205281 A1
(43) Pub. Date: Sep. 22, 2005

(54) Connection system for fireproofed electronic device

(76) Inventors: Thomas J. Bachinski, Lakeville, MN (US); Douglas Mark Holm, Minneapolis, MN (US); Brynn Douglas Rogers, Burnsville, MN (US)

Correspondence Address: Merchant & Gould P.C., P.O. Box 2903, Minneapolis, MN, 55402-0903, US

(21) Appl. No.: 10/802,529

(22) Filed: Mar. 17, 2004

(51) Int. Cl. H02G 3/08

(52) U.S. Cl. 174/50

(57) ABSTRACT

An electronic connection system suited for use with a fireproofed electronic device. The system includes a heat conductive wire having a connection point that includes a heat sensitive connecting material, and a biasing member configured to apply a tension force to the heat conductive wire point. The heat sensitive material is modified when heat is applied to the heat conductive wire such that the tension force from the biasing member thermally separates the heat conductive wire.

### BACKGROUND OF THE INVENTION

1. Field of the Invention

The present invention generally relates to connection systems for electronics, and more specifically relates to connection systems for electronics stored in fireproof structures.

2. Related Art

The importance of storing and protecting electronic data and some types of electronic devices has increased during the digital era and will continue to increase as individuals and companies continue to use and rely upon digital information. Two key dangers to digital information and important electronic equipment are theft and fire/heat related damage. Guarding against these dangers is often cumbersome, time consuming, and costly, and sometimes requires the use of redundant protection systems.

Theft of electronic information is typically guarded against using such tools as passwords, encryption, and other software to control electronic access to digital information. Protecting the electronic devices that hold the digital information against theft is typically done using locking mechanisms that lock closed access ports to the device or secure the device to an immovable or large structure such as a desk. Sometimes electronic devices are stored in safes or the digital information is copied onto back up discs such as CDROM or ZIP discs that are then stored in a safe. This type of storage of electronic devices is typically time consuming because the device or copied information must be moved in and out of the safe every time it is used.

Protection of digital information and electronic devices against fire/heat damage is less common than protection against theft primarily because of the associated costs of such increased protection and the low risk of the occurrence of a fire. However, fire/heat protection is becoming more and more important as the cost of electronic devices increases and the amount and type of information that can be stored electronically expands. For example, it is now common to store family photo albums electronically by scanning the photos into digital format or by taking the pictures with a digital camera. It is now possible to store thousands of pictures on a few CDROM discs or on a single hard drive, which increases the importance to an individual of protecting the information against even the remote chance of fire/heat damage. Another example relates to back up information for company computer systems/networks. Typically, back up copies of the network must be made on a regular basis and the back up copies stored in a safe place. Because of the great importance of back up information, the company may be willing to expend large cost to ensure protection against even the remote chance of fire/heat damage.

### SUMMARY OF THE INVENTION

The present invention generally relates to connection systems for heat sensitive devices, and more particularly relates to thermal protection connection systems for fireproofed electronic devices. Another aspect of the present invention relates to electronically accessing electronic devices and electronic information stored in a container that is fireproofed and/or configured as a safe with locking and unlocking capabilities.

One aspect of the invention relates to a connection system suited for use with a fireproofed electronic device. The system includes a heat conductive structure that is configured to transfer a communication signal and includes a connection point having a heat sensitive material. When heat is applied to the heat conductive structure the heat sensitive material is modified to thermally separate the heat conductive structure at the connection point.

Another aspect of the invention relates to a fireproof system for protecting a heat sensitive device. The system includes a heat resistant container having an internal chamber sized to house the heat sensitive device, and a connection system including a heat conductive structure that extends from outside the heat resistant container into the internal chamber of the heat resistant container. The heat conductive structure is configured to transfer a communication signal from outside the heat resistant container to the heat sensitive device. The heat conductive structure also includes a connection point positioned inside the internal chamber that includes a heat sensitive material. A source of applied to the heat conductive structure modifies the heat sensitive material to thermally separate the heat sensitive device from the heat source.

Another aspect of the invention relates to a method of protecting an electronic device from heat damage using a heat resistant container and a connection system. The connection system includes a heat conductive structure having a heat sensitive member. The method includes the steps of enclosing the electronic device in the heat resistant container, coupling the heat conductive structure to the electronic device, extending the heat conductive structure between an interior and an exterior of the heat resistant container, and modifying the heat sensitive member when heat is applied to the heat conductive structure to thermally separate the heat conductive structure thereby protecting the electronic device from heat damage.

Another method according to principles of the present invention relates to a method of protecting a heat sensitive device from heat damage using a heat resistant container and a connection system. The connection system includes a heat conductive structure having a connection point. The method may include the steps of enclosing the heat sensitive device in the heat resistant container, coupling the heat conductive structure to the heat sensitive device, extending the heat conductive structure between an interior and an exterior of the heat resistant container, and thermally separating the heat conductive structure at the connection point when heat is applied to the heat conductive structure thereby protecting the heat sensitive device from heat damage.

The above summary of the present invention is not intended to describe each disclosed embodiment or every implementation of the present invention. Figures in the detailed description that follow more particularly exemplify embodiments of the invention. While certain embodiments will be illustrated and describing embodiments of the invention, the invention is not limited to use in such embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of one example electrical connection system according to principles of the present invention;

FIG. 2 is a top perspective view of one example fireproofed electronic device that includes the example electrical connection system shown in FIG. 1;

FIG. 3 is a cross-sectional view of the fireproofed electronic device shown in FIG. 2 taken along cross-sectional indicators 3-3;

FIG. 4 is a front perspective view of another example fireproofed electronic device according to principles of the present invention that also includes locking and unlocking capabilities and wireless communication capabilities;

FIG. 5 is a rear perspective view of the device shown in FIG. 4;

FIG. 6 is a top perspective view of another example fireproofed electronic device according to principles of the present invention;

FIG. 7 is a cross-sectional view of the device shown in FIG. 6 taken along cross-sectional indicators 7-7;

FIG. 8 is a cross-sectional view of another example fireproofed electronic device according to principles of the present invention having connecting adapters within the fireproofed container and the wire assembly molded into an exterior wall of the fireproofed container;

FIG. 9 is a cross-sectional view of another example fireproofed electronic device according to principles of the present invention having a wireless connection system within the fireproofed container;

FIG. 10 is a side view of an example wire feed-through member according to principles of the present invention; and

FIG. 11 is a front perspective view of the example wire feed-through member shown in FIGS. 2 and 3.

While the invention is amenable to various modifications and alternate forms, specifics thereof have been shown by way of example and the drawings, and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present invention generally relates to connection systems for electronic devices, and more particularly relates to electrical connection systems for fireproofed electronic devices. Another aspect of the present invention relates to thermally protecting electronic devices and electronic information stored in a fireproofed container that may also be configured as a safe with locking and unlocking capabilities.

As used herein the term “safe” is defined as a place or receptacle to keep articles freed from harm or risk. The term “electronic device” is defined as any device that includes electronic components or functionality that is dependent upon the use of electronic power. The term “biasing member” is defined as a member or device that expends a biasing force, such as a force provided by a spring that when moved beyond a rest state provides a biasing force in an attempt to return to the rest state. The term “electrically conductive” is defined as having properties of conducting electrons and electronic current. The term “thermal” or “thermally” is defined as relating to heat or involving a state of matter dependent upon temperature. The terms “thermal separation” and “thermally separate” are defined to include a separation that substantially eliminates the transfer of heat, and may include physical separation as a means of providing the elimination of heat transfer. A “heat conductive wire” or a “thermally conductive member” are generally defined as a structure that conducts heat and is configured for transferring a communication signal. A “communication signal” is defined as any signal configure for and used to communicate information.

Stringent fire ratings have been established specifically for electronic equipment to ensure that equipment provided for fire/heat damage protection are rated for common fire/heat damage circumstances. Underwriter Laboratories (UL) has defined three classes of fire rated storage devices for different interior temperature and humidity conditions that reflect the type of material being stored in the device. Class 350 rated devices are intended to protect paper records, class 150 rated devices are intended to protect paper and nonpaper records such as EDP media (magnetic tapes) and photographic records, and class 125 rated devices are intended to protect flexible computer discs in addition to those items protected by the class 150 rated device. The number associated with each class represents the maximum interior temperature of the device when the exterior of the device is exposed to certain conditions for certain time periods. These ratings also provide for 80% or less humidity in the device. An example fire rated device for electronic media is the MediaVault™ made by Safetyfile, Inc of Minnetonka, Minn., which device is UL class 125, one hour rated media storage safe (temperatures up to 1700° F. for at least one hour).

Common materials used for fire/heat damage resistant containers for electronic devices typically impede any wireless communication that may otherwise be available between the electronic device and other external equipment. Likewise, the materials used in safes that are strong and durable enough to impede breaking into the safe also impede wireless communication. As a result, electronic access to any electronic devices stored in a safe or fire/heat resistant container must be performed with a hard wire connection. Such hard wire connections may eliminate the fire rating of an otherwise fire rated container.

Even if the fire rating of a container is maintained when providing a hard wire electrical connection between an exterior and an interior of the container, there exists a further drawback related to the thermal sensitivity of most electronic devices and information. Typically, the wires that provide the electrical connection with the electronic device are also thermally conductive. As a result, heat applied to a portion of the wire on the exterior of the fireproofed container will travel along the length of the wire to that portion of the wire in the interior of the fireproofed container. This transferred heat along the wire can damage the electronic device. The present invention addresses this potential thermal conductivity issue by providing a way in which the connecting wire is thermally disconnected within the interior of the fireproofed container when a predetermined temperature in the wire is reached.

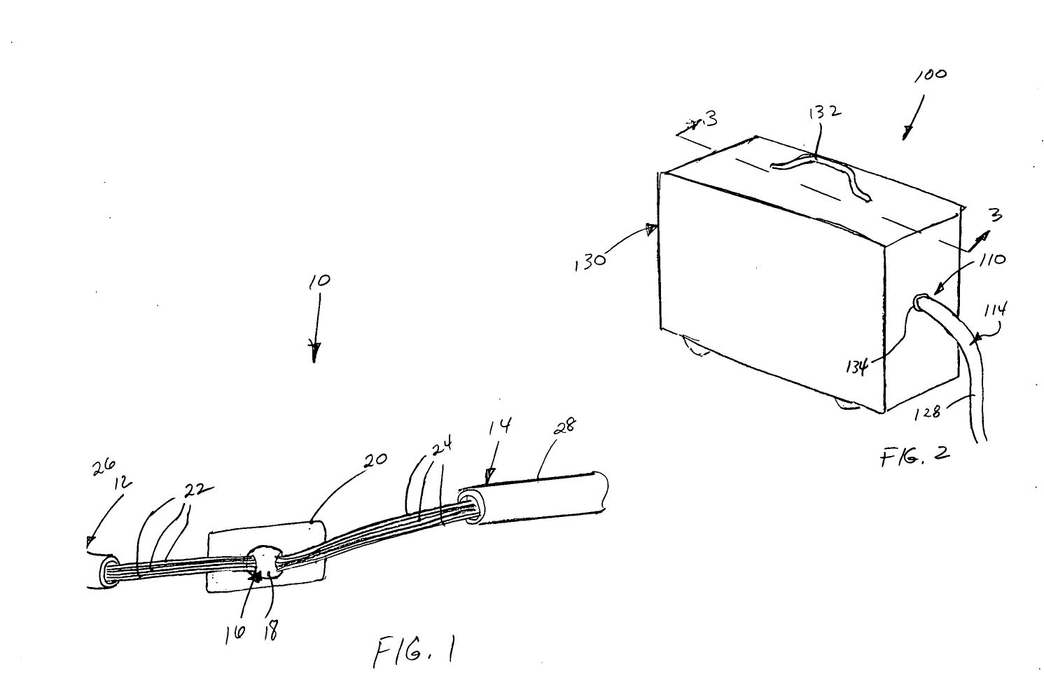

Referring now to FIG. 1, a schematic illustration of an electronic connection system 10 is shown. The system 10 includes first and second wire assemblies 12, 14, a connection point 16, a connecting material 18, and a biasing member 20. The first and second wire assemblies 12, 14 include respective first and second sets of heat conductive wires 22, 24 and first and second insulating members 26, 28. The first and second sets of wires 22, 24 are connected at the connecting point 16 with the connecting material 18. The biasing member 20 applies a tension force relative to the first and second sets of wires 22, 24, for example, a tension force applied axially along the first and second sets of wires 22, 24 or a tension force applied transverse to an axis of the first and second sets of wires 22, 24 at the connecting point 16.

The individual wires of the first and second sets of wires 22, 24 may be individually wrapped in an insulating material so as to prevent electrical conduction between the individual wires, or the wires may be bare so that they are in electrical connection with each other.

The connecting material 18 is a heat sensitive material preferably having the properties of high electrical conductivity and a thermal disconnection temperature. The thermal disconnection temperature of the connecting material may be related to the melting point of the connecting material, or may be related to the molecular structure or other properties of the material that would affect the ability of the material to maintain a thermal connection. The connecting material 18 not only physically connects the first and second sets of wires 22, 24 but also electrically and thermally connects those wires. The connecting material 18 may include any type of material having a relatively low melting point, or at least having a thermal disconnection temperature that either alone or under forces form a biasing member is lower than a critical temperature defined by a heat sensitive rating of the electronic device to which the electronic connection system is coupled. For example, if the electronic connection system is coupled to a computer hard disc drive, the thermal disconnection temperature of the connecting material 18 must be lower than the maximum allowable temperature within the hard drive that ensures that the hard drive is not thermally damaged.

The first and second wire assemblies 12, 14 may have different configurations than those shown in FIG. 1. For example, the first and second sets of wires 22, 24 may include only a single bare wire or may include multiple individually insulated wires that are connected to corresponding wires in the other wire assembly with separate pieces of connecting material that is also insulated so as to prevent electrical conduction between the wires at the connecting point. The insulating members 26, 28 may or may not be required depending on the insulated condition of the first and second groups of wires 22, 24. In some embodiments, the biasing member 20 may be coupled to one or more of the insulating members 26, 28 in order to apply the necessary tension force. Still further embodiments, the biasing member 20 may not be necessary when certain connecting materials are used at the connecting point 16. And yet further embodiments, a connecting material may not be necessary if the material used for the first and second sets of wires 22, 24 has certain properties or are modified in some way at the connecting point 16 such that the tension force applied by the biasing member would create an electrical disconnection between the first and second sets of wires 22, 24 when heat is applied through one of the sets of wires.

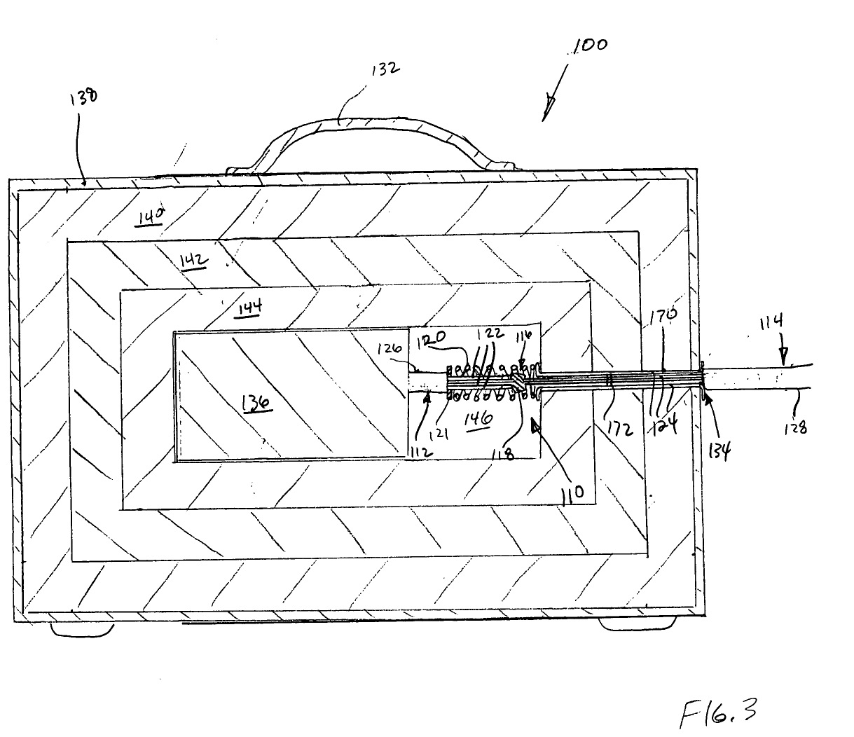

Referring now to FIGS. 2 and 3, an example fireproof system 100 that includes an electronic connection system 110 to provide electrical communication with an electronic device stored within a heat resistant container 130 is shown and described. The electronic connection system 110 includes first and second wire assemblies 112, 114, a connection point 116, a connecting material 118, and a biasing member 120. The first and second wire assemblies 112, 114 include respective first and second groups of heat conductive wires 122, 124 and first and second insulating members 126, 128.

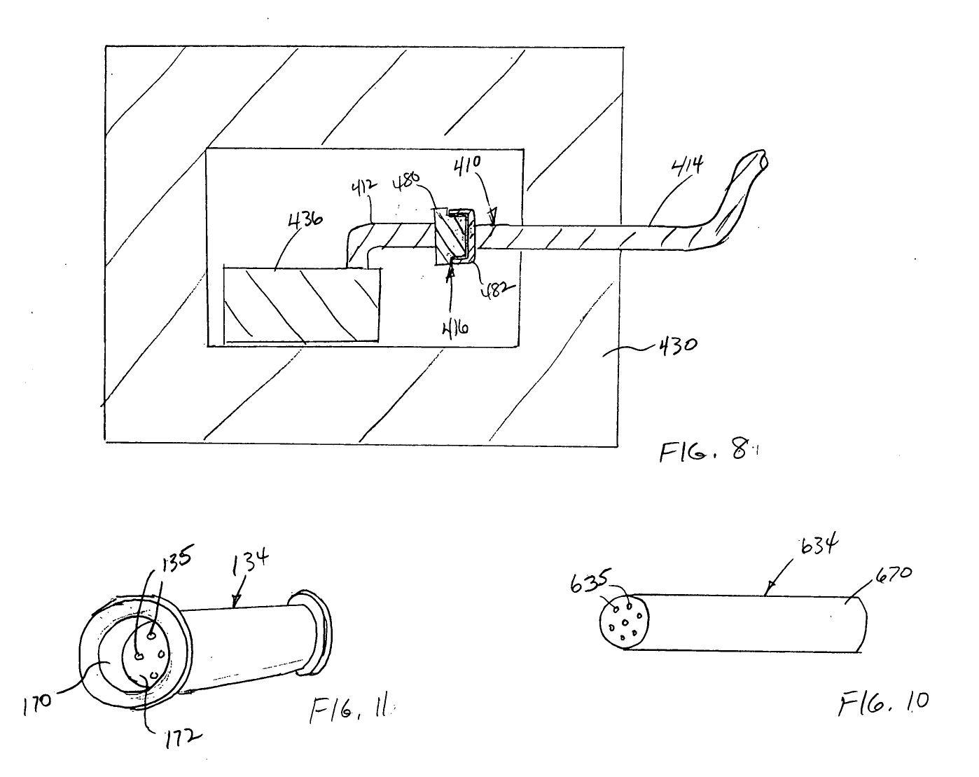

System 100 also includes a feed-through member 134, an electronic device 136, and first, second, third and fourth heat resistant layers 138, 140, 142, 144 that define an interior volume 146 sized to receive the electronic device 136. The feed-through member 134 extends through the layers 138, 140, 142, 144 to provide access for the second wire assembly 114 into the interior volume 146 for connection to the electronic device 136. The feed-through member 134 (see also FIG. 11) may include a side wall 170 that forms a passage for the second wire assembly 114, and a transverse plate 172 having holes 135 sized for each individual wire of the second set of wires 124. The feed-through member 134 may be filled with a heat resistant adhesive that fills any voids between the wires 124 and the feed-through member 134, and the heat resistant adhesive may also be applied between an exterior of the feed-through member 134 and the heat resistant container to ensure the proper fire rating for the system 100. FIG. 10 illustrates another example feed-through member 634 that includes a solid cylindrical member 670 with holes 636 sized for each individual wire of the set of wires passing through a heat resistant container.

The electronic connection system 110 may further include a biasing member stop 121 that engages one end of the biasing member 120 while an opposing end of the biasing member 120 engages a portion of the feed-through 134 or a side wall of the fourth layer 144 adjacent to the entry point of the second group of wires 124 into the interior volume 146. In FIG. 3, the biasing member 120 is arranged in a compressed state between the feed-through member 134 and the biasing member stop 121 thereby providing a biasing force at the connection point 116. In other embodiments, the biasing member may be secured directly to the wires 122, 124 or other features of the wire assemblies 112, 114. As discussed above, the biasing force applied by biasing member 120 facilitates an electrical disconnection of the first and second wire assemblies 112, 114 when heat is conducted through the second group of wires 124 of the second wire assembly 114.

The electronic device 136 may be any device having electronic components or the capability of communicating electronically. For example, device 136 may be a computer hard drive or other electronic media storage device, electronic media, a computer processor, a mother board, or any other computer-related devices that are desired to be protected from heat damage and require an electrical connection from the interior volume to an exterior of fireproof system 100.

The various layers 138, 140, 142, 144 may include any suitable fire resistant material having an appropriate thickness for the desired fire rating to protect the electronic device 136 from heat damage. The system 100 may be designed so that the electronic device 136 is permanently mounted within the interior volume 146 or may be designed so that the electronic device 136 is removable and/or replaceable through some type of access opening into the interior volume 146.

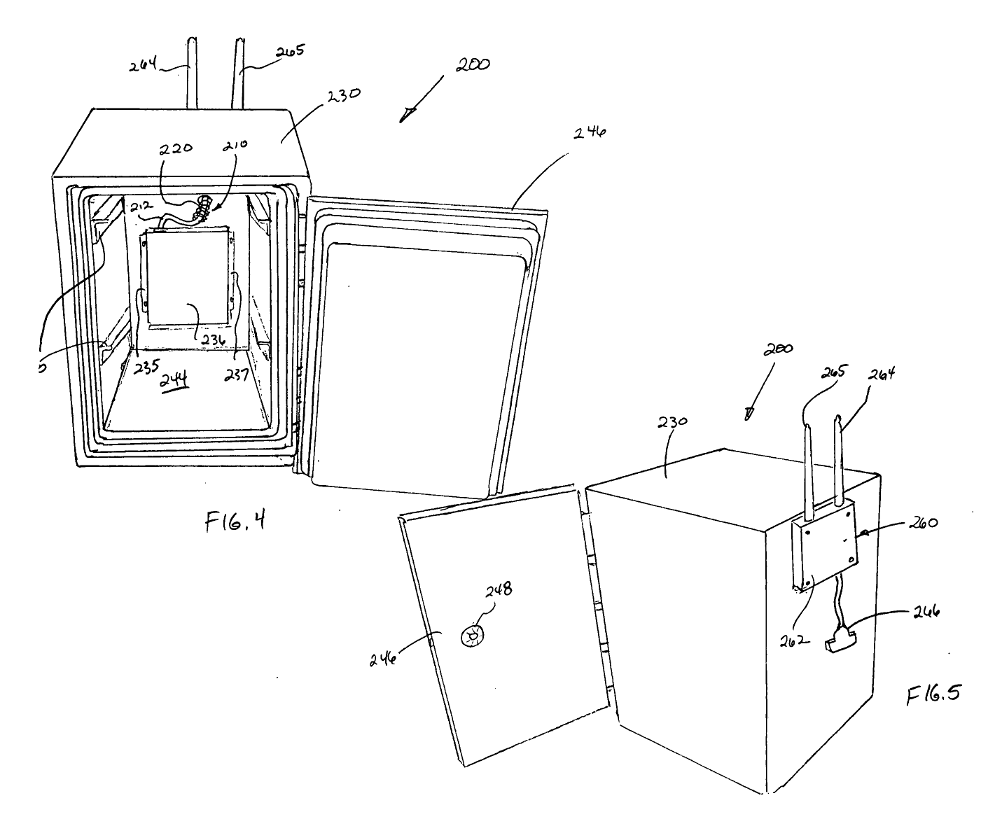

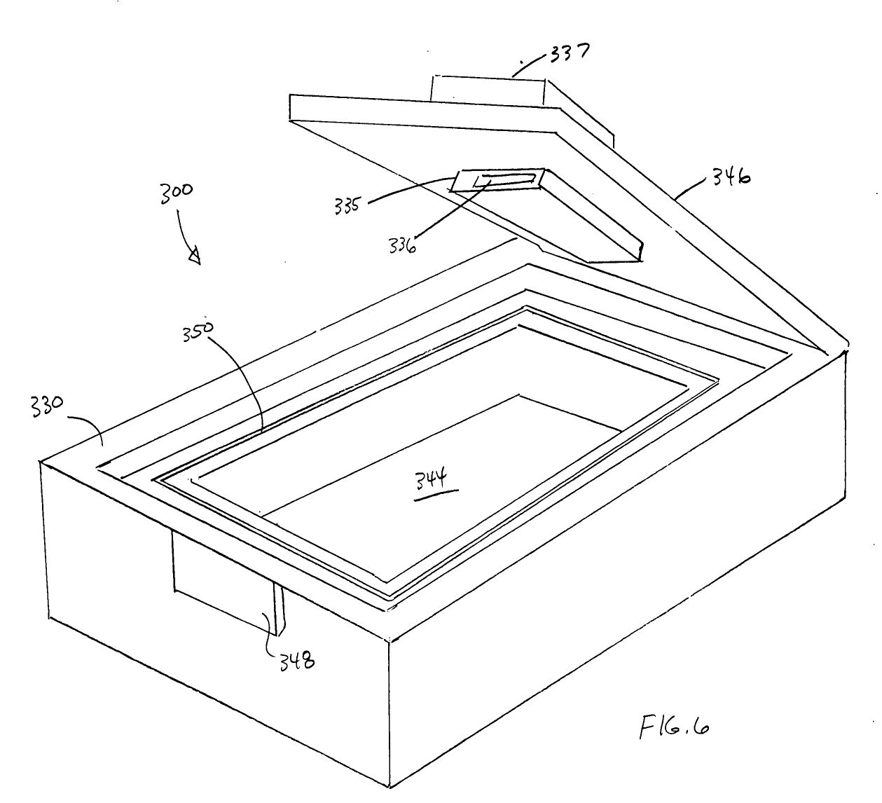

Referring now to FIGS. 4 and 5, a fireproof safe assembly 200 is shown. Assembly 200 includes electronic connection system 210, a heat resistant container 230, an electronic device 236, and a wireless communication system 260. The electronic connection system 210 includes a biasing member 220 and a wire assembly 212 along with other features (not shown) that are the same or similar features as those of the electronic connection system 10 shown in FIG. 1.

The heat resistant container 230 defines an interior volume 244 sized to receive the electronic device 236, and further includes a door 246 providing access to the interior volume 246 and a lock 248 having locking and unlocking capabilities for opening and closing the door 246. The wireless communication system 260 includes a housing 262, first and second antennas 264, 265, and may include a connector 266 for a hard wire connection if the wireless features of system 260 fail or are undesired. A wire assembly (not shown) of the electronic connection system 210 extends through a sidewall of the heat resistant container 230 to provide electrical communication between the electronic device 236 within the interior volume 244 and the wireless communication system 260. Thus, if a fire or other extreme heat condition exists on the outside of the assembly 200, which may, for example, destroy the wireless communication system 260, the electronic device 236 can be protected from heat damage when the electronic connection system 210 thermally disconnects the wire assembly 212.

Assembly 200 may also include mounting brackets 235, 237 for mounting the electronic device 236 to an interior wall of the heat resistant container 230, and may also include tracks 250 or similar mounting structures for mounting a partition member (not shown) within the interior volume member 244 to separate the electronic device 236 from the remaining useful space within interior volume 244. The tracks 250 may also be used to support shelves (not shown) within the interior volume for more efficient use of space.

The use of the electronic connection system 210 and the wireless communication system 260 provide several advantages over a fireproof safe that merely stores electronic media or electronic equipment under fire rated conditions. One advantage of the assembly 200 is that the assembly can be stored at any convenient location, such as in a closet or other storage location while providing electronic communication between the electronic device 236 and a user who is communicating with the stored device 236. When a wireless connection cannot be maintained via the wireless communication system 260, a hard wire connection can be established with the enclosed electronic device 236 via the connector 266.

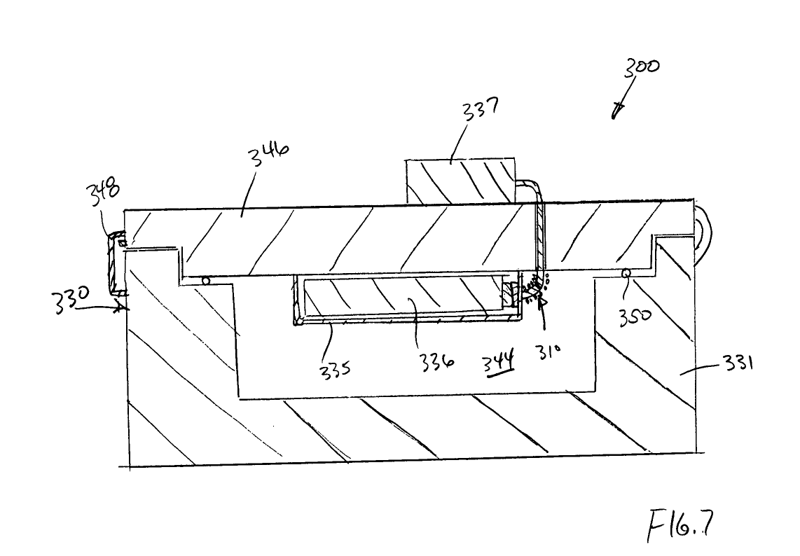

Referring now to FIGS. 6 and 7, another example fireproofed electronic assembly 300 is shown and described. Assembly 300 includes a heat resistant container 330 having a main body portion 331, a door 346, and an interior volume 344. The assembly 300 also includes a first electronic device 336 mounted to the door 346 via a mounting bracket 335, and a second electronic device 337 mounted on the exterior of the door 346. The assembly 300 also includes an electronic connection system 310 that provides an electronic connection between the first and second electronic devices 336, 337 and is configured to electronically disconnect as described above with respect to electronic connection system 310.

The mounting bracket 335 may include quick release mounting features and electronic connection features to facilitate a quick release and electronic connection with the first electronic device 336. The second electronic device 337 may be any number of different electronic devices such as, for example, the wireless communication system shown and described with reference to FIGS. 4 and 5, a computer system that includes a processor and/or mother board, or a connection port for transferring communication signals and thermally connecting other devices to the first electronic device 336. Example connection ports include USB, parallel, IR, RF, optical, or other known connection ports. The second electronic device 337 may be a relatively disposable device having a value much lower than the value of the hardware and/or information stored on the device 336.

The assembly 300 may also include a handle 348 that securely holds closed the door 346 relative to the main body 331. The handle 348 may include locking capabilities so as to provide a “safe” function in addition to the fireproofing function described above. Assembly 300 may also include a seal 350 positioned between the door 346 and the main body 331 that provides a moisture/air seal within the inner volume 344.

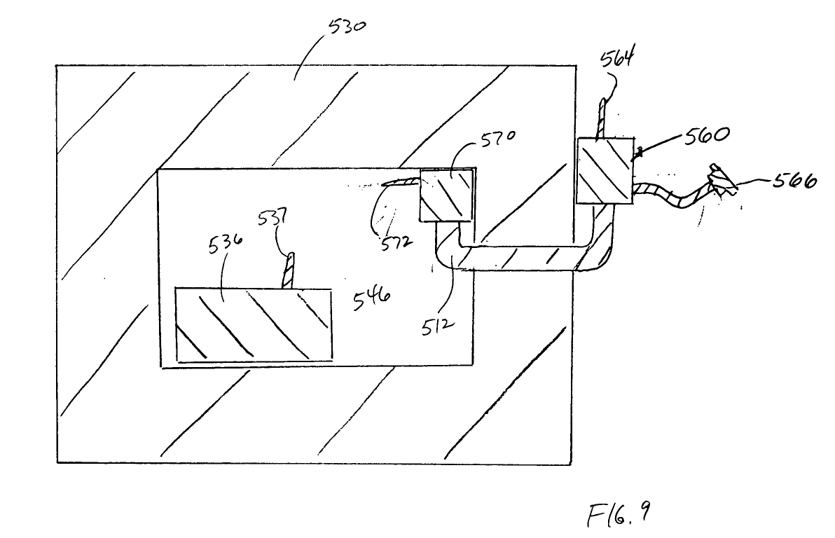

Referring now to FIG. 8, another example fireproofed electronic device 400 is shown in cross-sectional view having an electronic connection system 410, a heat resistant container 430, and an electronic device 436. The electronic connection system 410 includes first and second wire assemblies 412, 414 and a connection point 416 that includes first and second connection members 480, 482. The second wire assembly may be molded into an exterior wall of the heat resistant container 430 so that a heat resistant bond exists between the second wire assembly 414 and the heat resistant container 430. Such a molded connection may be formed when molding the heat resistant container from moldable material (e.g., a moldable ceramic fiber or other heat resistant fiber and a binder) using a molding process (e.g., a compression molding, vacuum molding process, or casting process).

The first and second connection members 480, 482 may be respective female and male connectors that are configured such that when engaged together form an electrical and a thermal connection between the first and second wire assemblies 412, 414. The connection members 480, 482 may also be configured to thermally disconnect when a predetermined temperature is reached at the connection point 416 due to heat being transferred through second wire assembly 414.

Referring now to FIG. 9, another example fireproofed electronic device 500 is shown in cross-sectional view. Device 500 includes a wire assembly 512, a fireproofed container 530, an electronic device 536 having an antenna 537, a wireless communication receiver 460 having an antenna 564, and a wireless communication transmitter 570 having an antenna 572. The electronic device 536 includes wireless communication receiver capabilities such that a wireless signal received via the antenna 564 of receiver 560 and transferred via wire assembly 512 to transmitter 570 can be wirelessly transferred via the antenna 572 of transmitter 570 to the antenna 537 of the electronic device 536. The wire assembly 512 is molded into or otherwise mounted in an exterior wall of the fireproofed container 530 such that an interior volume 546 maintains a desired fire rating. This embodiment provides for thermal protection of electronic device 536 as a result of the wireless communication possible between the transmitter 570 and the electronic device 536 when heat is conducted via wire assembly 512 from an exterior to the interior volume 546 of the fireproofed container 530.

The transmitter 570 and electronic device 536 may use different types of technology to communicate information, such as, for example, infrared, inductive telemetry, radio frequency, and fiber optics. The receiver 560 may also be capable of communicating wirelessly with remote devices using such communication technologies. In some embodiments, the receiver 560 may use the hard wire connector 566 to communicate with a remote source of information if the wireless functions of receiver 560 are not desired or available.

The thermally conductive wires described above with reference to the example embodiments may be configured for transferring a communication signal. Some example communication signals include digital, analog, and optical signals. The wires or other structure used to carry the communication signal may be constructed as, for example, electrically conductive wires, fiber optic wires, or any other configuration or structure suited for transferring a communication signal while possessing properties of thermal conductivity.

In some embodiments of the connection systems described above, the connection point may be any structure or device capable of creating a thermal disconnect or thermal barrier along the thermally conductive structures. Some example structures provide a thermal disconnect as a result of thermal condition include, for example, a bimetallic mechanical switch that moves between opened and closed positions under predetermined thermal conditions, or a fuse or other device that includes a low temperature connect member that physically separates at a predetermined temperature. Another example embodiment that may be useful for creating a thermal barrier between a heat sensitive device housed inside a heat resistant container includes an cable or wire that is sufficiently long to dissipate any heat applied by a heat source to the wire or cable outside the container before the heat arrives at the heat sensitive device. These example structures may be particularly useful in applications related to thermally separating an electronic device from a source of otherwise damaging heat.

The present invention should not be considered limited to the particular examples or materials described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A connection system suited for use with a fireproofed electronic device, the system comprising a heat conductive structure configured to transfer a communication signal and having a connection point that includes a heat sensitive material, wherein heat applied to the heat conductive structure modifies the heat sensitive material to thermally separate the heat conductive structure at the connection point.

2. The system of claim 1, further comprising a biasing member configured to apply a tension force at the connection point.

3. The system of claim 1, wherein the heat sensitive material is a low temperature solder.

4. The system of claim 1, wherein the heat conductive structure includes a co-axial cable.

5. The system of claim 1, wherein the heat conductive structure includes first and second wire members that are coupled together at the connecting point with the heat sensitive material.

6. The system of claim 5, wherein the first wire member is configured to extend through an exterior wall of a heat resistant container that houses the electronic device, and the second wire member is configured to be coupled to the electronic device stored in the heat resistant container.

7. A fireproof system for protecting a heat sensitive device, the system comprising:
a heat resistant container having an internal chamber sized to house the heat sensitive device; and
a connection system including a heat conductive structure that extends from outside the heat resistant container into the internal chamber of the heat resistant container, the heat conductive structure being configured to transfer a communication signal from outside the heat resistant container to the heat sensitive device, the heat conductive structure having a connection point inside the internal chamber that includes a heat sensitive material;
whereby a heat source applied to the heat conductive structure modifies the heat sensitive material to thermally separate the heat sensitive device from the heat source.

8. The system of claim 7, further comprising a biasing member configured to apply a tension force to the heat conductive structure at the connection point.

9. The system of claim 7, wherein the heat resistant container includes an aperture extending between the interior and an exterior of the heat resistant container, the system further comprises a heat resistant feed-through member that extends through the aperture, and the first cable member extends through the heat resistant feed-through member.

10. The system of claim 7, wherein the heat sensitive device is a computer hardware device.

11. The system of claim 9, further comprising a heat resistant adhesive positioned within the heat resistant feed-through adjacent to the heat conductive wire.

12. The system of claim 7, wherein the heat resistant container comprises first and second housing members defining the internal chamber, the first and second housing members being sealed together with a heat resistant sealant.

13. The system of claim 7, wherein the heat resistant container includes a ceramic fiber and a binder material.

14. The system of claim 13, wherein the heat resistant container is formed using a vacuum molding, a compression molding, or a casting process.

15. The system of claim 7, wherein the heat conductive structure is molded into an exterior wall of the heat resistant container.

16. The system of claim 7, wherein the heat resistant container is a safe having locking and unlocking capabilities and heat resistant properties.

17. The system of claim 7, further comprising a safe having locking and unlocking capabilities and an interior cavity sized to receive the heat resistant container and the connection system.

18. The system of claim 7, further comprising a wireless communication system coupled to an exterior surface of the heat resistant container, wherein the heat conductive structure is couple to the wireless communication system.

19. A method of protecting an electronic device from heat damage using a heat resistant container and a connection system, the connection system including a heat conductive structure having a heat sensitive member, the method comprising:
enclosing the electronic device in the heat resistant container;
coupling the heat conductive structure to the electronic device;
extending the heat conductive structure between an interior and an exterior of the heat resistant container; and
modifying the heat sensitive member when heat is applied to the heat conductive structure to thermally separate the heat conductive structure thereby protecting the electronic device from heat damage.

20. The method of claim 19, wherein the heat sensitive material is a low temperature solder, and modifying the heat sensitive material includes melting the low temperature solder.

21. The method of claim 19, further comprising fixing the heat conductive wire within an exterior wall of the heat resistant container.

22. The method of claim 19, wherein the system further comprises a biasing member and the method further includes applying a tension force to the heat conductive wire at the connection point with the biasing member.

23. The method of claim 22, wherein applying the tension force includes coupling the biasing member to the heat conductive wire and to the heat resistant container.

24. The method of claim 19, wherein the heat resistant container includes at least first and second housing members that define an interior cavity, and enclosing the electronic device includes sealing the first and second housing members together with a heat resistant adhesive.

25. The method of claim 19, wherein the heat resistant container is a safe having locking and unlocking capabilities.

26. The method of claim 25, wherein the safe includes a wireless communication system, and the method further comprises mounting the wireless communication system on an exterior surface of the safe and coupling the heat conductive wire to the wireless communication system and to the electronic device.

27. A method of protecting a heat sensitive device from heat damage using a heat resistant container and a connection system, the connection system including a heat conductive structure having a connection point, the method comprising:
enclosing the heat sensitive device in the heat resistant container;
coupling the heat conductive structure to the heat sensitive device;
extending the heat conductive structure between an interior and an exterior of the heat resistant container; and
thermally separating the heat conductive structure at the connection point when heat is applied to the heat conductive structure thereby protecting the heat sensitive device from heat damage.

28. The method of claim 27, wherein the system further comprises a biasing member and the method further includes applying a tension force to the heat conductive structure at the connection point with the biasing member.

29. The method of claim 28, wherein applying the tension force includes coupling the biasing member to the heat conductive structure.

30. The method of claim 27, enclosing the heat sensitive device includes mounting the heat sensitive device to the heat resistant container with a quick release mechanism.

31. The method of claim 27, wherein thermally separating the heat conductive structure includes physically separating the heat conductive structure at the connection point to disconnect the heat sensitive device from the source of the heat.
